(19) United States
(12) Patent Application Publication
(10) Pub. No.: US 2020/0389316 A1
(43) Pub. Date: Dec. 10, 2020

(54) SYSTEM AND METHOD PROVIDING PHYSICALLY AUTHENTICATED DIGITAL TRACKING AND ASSOCIATION

(71) Applicants: Alexander James Karp, escondido, CA (US); Gregory Frank Matula, escondio, CA (US)

(72) Inventors: Alexander James Karp, escondido, CA (US); Gregory Frank Matula, escondio, CA (US)

(21) Appl. No.: 16/875,567

(22) Filed: May 15, 2020

Related U.S. Application Data
(60) Provisional application No. 62/858,885, filed on Jun. 7, 2019.

(51) Int. Cl. H04L 9/32; H04L 9/06

(52) U.S. Cl. CPC H04L 9/3236; H04L 2209/38; H04L 9/0643

(57) ABSTRACT

A method and system comprising; a physical medium having a first unique identifier and a second unique identifier stored within; where said physical medium is in communication with a first distributed ledger having said first unique identifier associated with said second unique identifier stored within; where said distributed ledger is operatively connected with a first comparison algorithm providing; physical authentication of data associated with additional data elements; further provides mathematical coupling to further additional data which allows for novel visibility and management, including reducing inefficiencies and errors, within physical systems, for example product supply chains, without the need to fully replace current supply chain management systems.

### RELATED APPLICATION

This is a regular U.S. application claiming priority to U.S. Provisional Application Ser. No. 62/858,885, entitled System for Physically Authenticated Digital Tracking, filed on Jun. 7, 2019, the contents of which are herein incorporated by reference as if set forth in their entirety.

### FIELD OF THE INVENTION

The present disclosure relates to systems for storing and analyzing digital data of physical attribute information; further, management of physical items associated with said physical attribute information, and methods of use thereof.

### BACKGROUND

It is advantageous to track physical products throughout the product lifecycle from idea generation; through end-consumer use; to disposal. Current attempts to provide information about physical attributes of these products use a complex system of individual and batch product identifiers, human readable and/or machine-readable markings, databases, ledgers, and record books. Often these records are maintained in separate systems across various physical and digital locations, and across various organizations and companies. The separated record systems provide various inefficiencies and challenges. In one example, products are often tracked through groupings, such as batches or lots, which results in incomplete records about individual products. In addition to records being incomplete, said records are often duplicated which can lead to conflicting information, data loss, and resources expended on audits. Additionally, inconsistencies in data records of physical goods allows for falsified data such as counterfeit products; and prevents traceability which hampers recall notifications, and limits chain of custody verification. Current approaches to solve these problems generally rely on fully integrated new systems or may rely on replacing non-authenticated data. These attempted solutions require costly integration into multiple proprietary systems, and limits operational expansion into newer technologies and publicly available data elements.

### SUMMARY OF THE INVENTION

This present disclosure overcomes the disadvantages of the prior art by providing physical authentication for digitally stored data records comprising; a physical medium having a first unique identifier and a second unique identifier stored within; where said physical medium is in communication with a first distributed ledger having said first unique identifier associated with said second unique identifier stored within; where said distributed ledger is operatively connected with a first comparison algorithm providing the following steps;

Receiving said first unique identifier coupled with said second unique identifier, further associated with at least one first additional data element comprising physical attribute information to be stored; comparison to said first unique identifier associated with said second unique identifier stored within said distributed ledger; determination that received first unique identifier coupled with said second unique identifier is equal to stored first unique identifier associated with said second unique identifier; storage of said first additional data element in association with said first unique identifier coupled with said second unique identifier within said distributed ledger.

The present disclosure further provides authentication to at least a second additional data element comprising physical attribute information to be stored following the steps;

Receiving said first unique identifier associated with at least one second additional data element; storage of said first unique identifier in association with said second additional data element within said distributed ledger; further; receiving said first unique identifier coupled with second unique identifier, further associated with at least a third additional data element; comparison to said first unique identifier associated with second unique identifier stored within said distributed ledger; determination that received first unique identifier coupled with said second unique identifier is equal to stored first unique identifier associated with said second unique identifier; storage of third additional data element in association with said first unique identifier coupled with said second unique identifier within said distributed ledger;

Further said first comparison algorithm provides mathematical coupling of non-physically authenticated data performed by the following steps;

Comparison of said third additional data element with said second additional data element; determination of mathematical association of said second additional data element to said third additional data element; storage of said mathematical coupling within said distributed ledger.

Said physically authenticated data, associated with additional data elements; mathematically coupled to further additional data allows for novel visibility and management, including the reduction of inefficiencies and errors, within physical systems, for example product supply chains.

### BRIEF DESCRIPTION OF THE DRAWINGS

Various other objects, features, and attendant advantages of the present disclosure will be more fully appreciated from the following detailed description when considered in connection with the accompanying drawings in which like reference characters designate like or corresponding parts throughout the several views, and wherein:

FIG. 1 illustrates automatic data capture utilizing a data input device 2001, of a first unique identifier, comprising an Item ID, 1012, derived from an identification designation scheme, 1011; further said Item ID is associated with additional data, which may include a second unique identifier 102 and/or may include additional information, including a first additional data element 201, a second additional data element 202, a third additional data element 203; further depicting a distributed ledger data system 301, operatively connected with a first comparison algorithm 400, further said distributed ledger having said first unique identifier associated with said additional information stored within a database comprising 4001, 4002, 4003, 4004, according to one or more aspects of the disclosure.

FIG. 2 illustrates a physical medium 1000 having a first unique identifier 101, and a second unique identifier 102 stored within physical memory 1001, 1002 respectively; where automatic data capture is performed, at least partially, through inductive coupling with said physical storage medium; further with cryptographic encoding at time of transmission, such as RFID 2001; Further, a data input device assists in communication with a cloud distributed ledger with cloud access protocols 300; Allowing for a first comparison algorithm 400 and the following authentication steps 402; Receiving said first unique identifier coupled with said second unique identifier 103, further associated with at least one first additional data element 201 comprising of physical attribute information to be stored; Comparison to said first unique identifier associated with said second unique identifier stored within said distributed ledger including databases; Determination that received first unique identifier coupled with said second unique identifier is equal to stored first unique identifier associated with said second unique identifier, utilizing a database 4001; Storage of said first additional data element in association with said first unique identifier coupled with said second unique identifier within said distributed ledger, including database 4002, according to one or more aspects of the disclosure.

FIG. 3 illustrates a physical medium having a first unique identifier and a second unique identifier stored within; where automatic data capture is performed, such as a barcode scan 2002; Further, a data input device assists in communication with a cloud distributed ledger; Allowing for a first comparison algorithm and the following association steps 403; Receiving said first unique identifier associated with at least one second additional data element 202; Storage of said first unique identifier in association with said second additional data element within said distributed ledger including database 4003; according to one or more aspects of the disclosure.

FIG. 4 illustrates a first comparison algorithm providing the following mathematical coupling steps 404; Further; Receiving said first unique identifier coupled with second unique identifier, further associated with at least a third additional data element 203; Comparison to said first unique identifier associated with second unique identifier stored within said distributed ledger including database; Determination that received first unique identifier coupled with said second unique identifier is equal to stored first unique identifier associated with said second unique identifier; Storage of third additional data element in association with said first unique identifier coupled with said second unique identifier within said distributed ledger; Comparison of third additional data element with second additional data element; Determination of mathematical association of said second additional data element to said third additional data element; Storage of said mathematical coupling 405 within said distributed ledger including database 4004, according to one or more aspects of the disclosure.

FIG. 5 illustrates a physical medium having a first unique identifier and a second unique identifier stored within; where automatic data capture is performed; further, a data input device 2000 in communication with a cloud access protocol including database 4002, further connected to a first comparison algorithm operating on a data system 4000, further connected to a plurality of distributed ledgers 6000, including data connected to a supplier 6001, a manufacturer 6002, and a distributor 6003; where said distributed ledger comprising at least one blockchain of linked records 6100. Said blockchain of linked records comprising first additional data element comprising of physical attribute information 6101, linked to a second additional data element 6102, further linked to a third additional data element 6103; including additional linkages 6104, according to one or more aspects of the disclosure.

FIG. 6 illustrates a distributed ledger comprising a plurality of blockchains of linked records 6200, 6300, 6400, 6500, 6600, comprising data elements of physical attribute information from a supplier 6001, a manufacturer 6002, and a distributor 6003. Physically authenticated genesis block 6201; protected viewing block 6202, additional data blocks 6203, shared physically authenticated blocks 6204, 6301, 6401, shared additional data blocks 6205, 6305, 6405, internal restricted access blocks 6303, 6403; cross partner restricted access blocks 6502, 6602; shared physically authenticated blocks 6304, 6404, 6501, 6601, shared public blocks 6206, 6306, 6406, 6506, 6606, according to one or more aspects of the disclosure.

FIG. 7 illustrates a data input device 2001 in communication with a cloud distributed ledger with cloud access protocols 300, connected to data portal 4100, connected to an existing manufacturing management system 6003, through use of a dedicated gateway connection 4001 at a similar physical location of data capture 6005, operatively connection to a shared database 6004 within said management system 6003, comprising a warehouse management system 601, an enterprise resource planning 602, a manufacturing execution system 603, and additional systems required 604, according to one or more aspects of the disclosure.

FIG. 8 illustrates the difficulties of tracking physical products in an exemplary supply chain consisting of data elements of raw materials 7001, 7002, connected to a data element of a contract manufacture 7003; further data elements of subsystem components 7009, 7010 connected to a second data element of a second contract manufacture 7011; yet further connected to a multiple of data elements of factories 7004, 7012; further connected to a multiple of data elements of inventory locations 7005, 7013; further connected to data elements of a multiple of distribution locations 7006, 7014; yet further connected to data elements for a multiple of retail locations 7007, 7008, 7015, 7016, according to one or more aspects of the disclosure.

FIG. 9 illustrates data elements connected in a branching linear method, where said data elements are simultaneously shared, utilizing at least one blockchain of linked records, where 7017 represents the full set of branching data elements 7006, 7014; further where 7018 represents the full set of branching data elements 7007, 7008, 7015, 7016; according to one or more aspects of the disclosure.

FIG. 10 illustrates an exploratory product assembly factory with physical authentication through automatic identification and data capture 8001, comprising a plurality of assembly stations 800 combine with automatic inspection 808, 809; further compared to an exploratory product assembly without physical authentication 8002, comprising a plurality of assembly stations 806, thereby requiring additional time to assemble a similar product, further requiring additional resources to perform an audit of final product production 810. The figure further illustrates said automatic identification and data capture assembly station 800, comprising parts 801, an RFID reader 802, a product assembly 803, an assembly operator 804, and transfer 805 to an additional station 800. The figure further illustrates where said assembly station 806, comprising parts 811, a barcode reader 807, a product 812, an assembly operator 813, and transfer 814 to an additional station; according to one or more aspects of the disclosure.

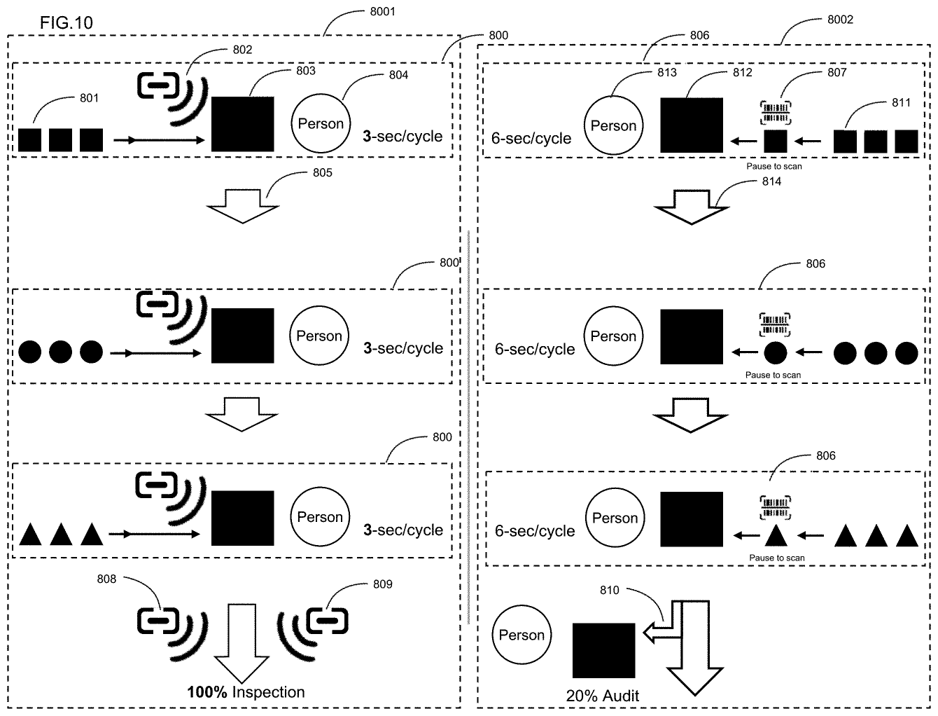

### DETALIED DESCRIPTION

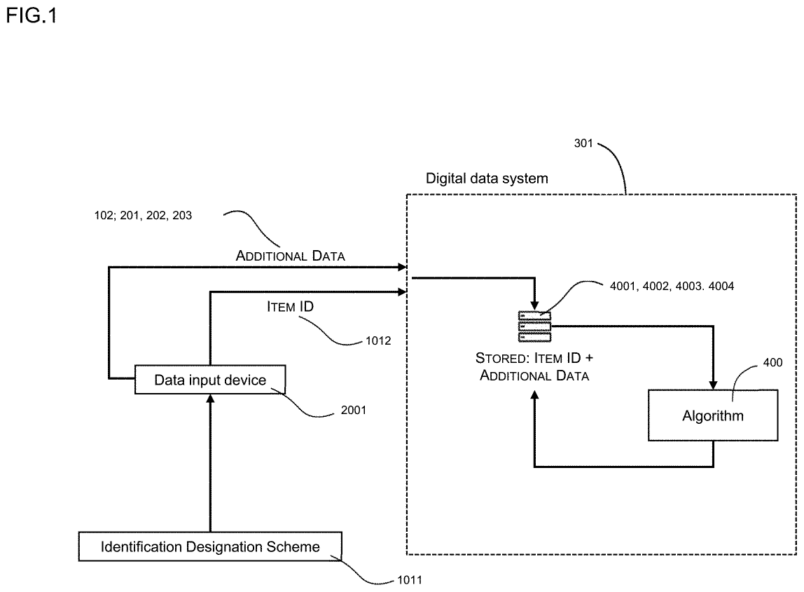

The present disclosure outlines a system that utilizes an identification designation scheme 1011, a data input device 2001, a digital data system 301, and an algorithm 400 analyzing data associations (FIG. 1).

The identification designation 1011, for the purposes of this disclosure, consisting of a First Unique ID number 101, as an example referred to as ItemID 1012, and may be assigned to any/all unique materials, items, subsystems, products, nodes, elements, processes, locations, transactions, personnel, organizations, and/or companies.

The data input device 2001, for the purposes of this disclosure, may be a mobile or stationary electronic device capable of reading and recording the ItemID 1012 of the Identification Designation Scheme 1011, and transmitting or sending said ItemID to the digital data system 301. Said electronic device may also transmit additional data with or without said ItemID. Additional data 201 may include, unique identification designation of said device, date and time from said device time keeping chip, GPS location of said device, or any data recorded by said device

The digital data storage system 301, for the purposes of this disclosure, may be a physical or virtual computer database with the ability to store data from said data input device 2001 and make said data readable for algorithmic calculations 400.

The algorithm 400, for the purposes of this disclosure, may be defined as a set of computational instructions which make comparisons of said data entries and may calculate connections or associations between said data entries.

ItemID numbers 1012 are unique and never duplicated, to provide complete traceability for each ItemID number. Said ItemID numbers may be systematically created and assigned during operations, or may be pre-generated and assigned upon first entrance into the data system 301

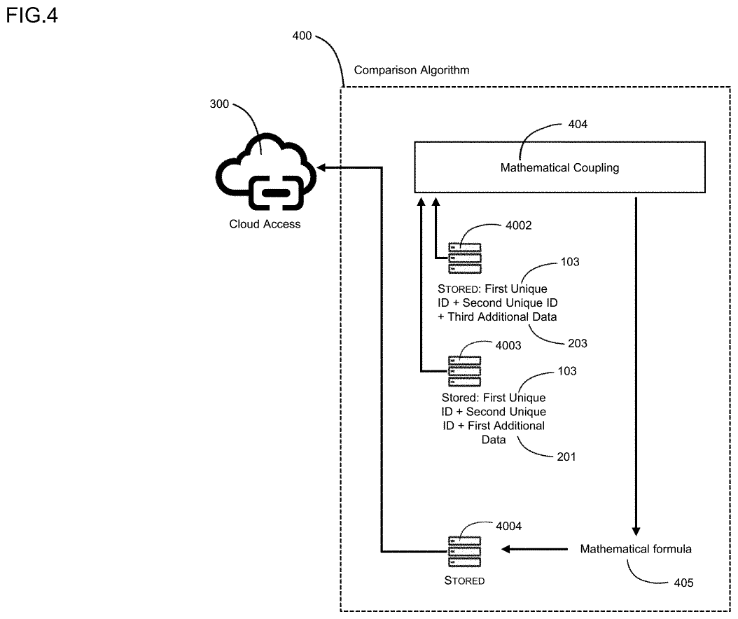

Said algorithm 400 determines physical authentication, and may include mathematical coupling 404 (FIG. 4), of an ItemID 1012, by first associating known additional data 102; 201, 202, 203 to said ItemID number.

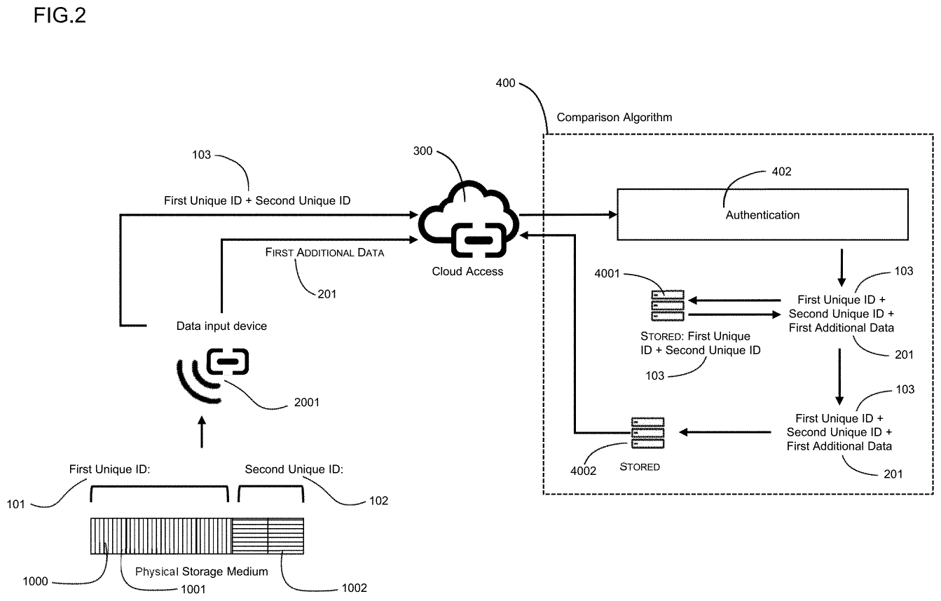

For example, at the time of manufacture, a physical storage medium is imprinted with a unique physical identification number 102, for the purpose of this example called a TagID. Said TagID is readable through electronic data input devices 2001 and said TagID is permanent and not changeable. The first read of said TagID is transmitted and stored on the data storage system 4001. Upon receiving the said first read, said algorithm 400 associates an ItemID to said TagID 103 where said ItemID is also stored on the data storage system 4001 (FIG. 2).

In order to provide physical authentication for subsequent reads both the TagID and commissioned ItemID 103 may be transmitted to the data capture system, utilizing a data input device 2001. A read may be authenticated when said Algorithm 400 compares the TagID 101 and ItemID 102 at the time of said read, to the value of the associated TagID and ItemID 103 stored on the data capture system from the first tag read (FIG. 2).

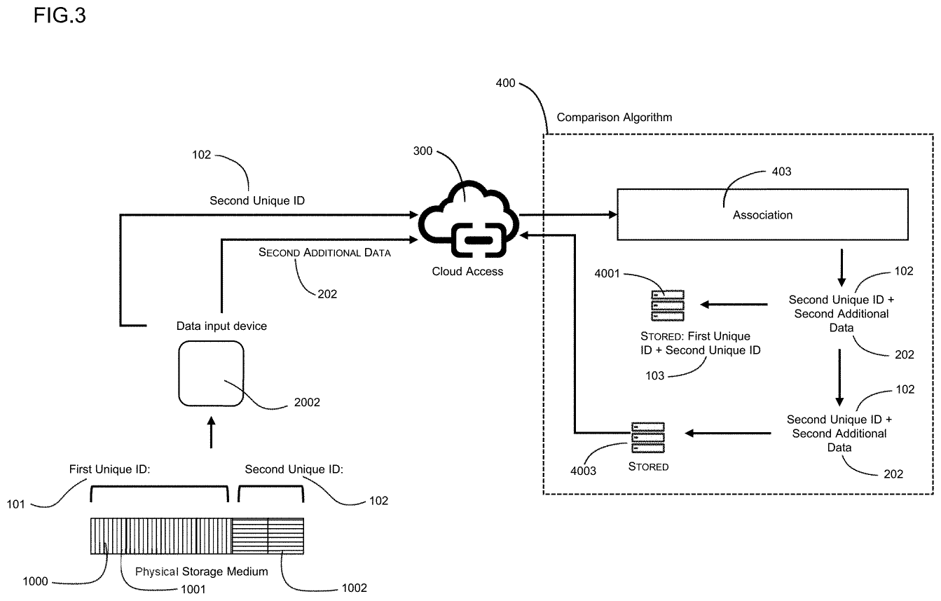

Said algorithm may associate additional data 201, such as predefined physical data at the time of manufacture, or may associate data collected from secondary physical data capture systems, utilizing data input devices 2002. Example, said data input device may provide unique physical data such as Global Positioning System coordinates or a unique identification of the data input device, or other sensor data such, as environmental data. Said algorithm may associate additional ItemID numbers to one another. For example, said algorithm may associate one unique ItemID to second unique ItemID to signify a configuration change of the physical item being tracked by the ItemIDs. In another example, an ItemID and TagID 103 is associated to a second TagID 102 when the physical medium is replaced due to being damaged (FIG. 3)

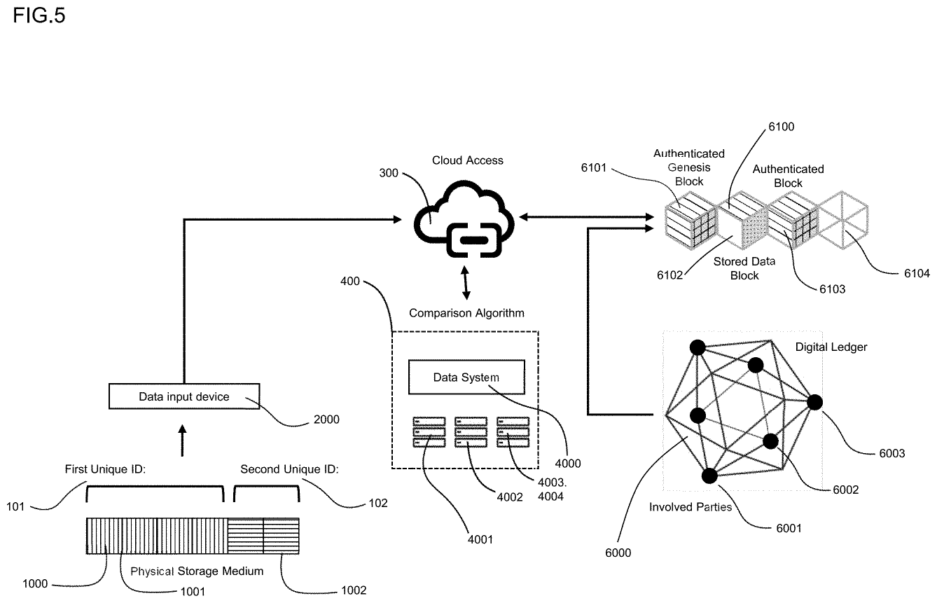

Said algorithm 400 may also record said association data as a completed transaction in a digital ledger 6000, such as a block in a Blockchain 6100 (FIG. 5).

Using a digital ledger, such as Blockchain, allows for recorded associations to be made accessible to and shared across various data input devices 2000, organizations, companies, and involved parties 6001, 6002, 6003.

In one example, additional data input devices 2000 may be connected to said Algorithm 400 through various wireless or wired data transfer systems. The distributed digital ledger 6000 may be used to record 4000 additional data associated with the ItemID 101 and/or TagID 102. Making associations between multiple ItemIDs and secondary data may allow for said Algorithm to determine a probabilistic mathematical value 405 of physical authentication (FIG. 4, FIG. 5).

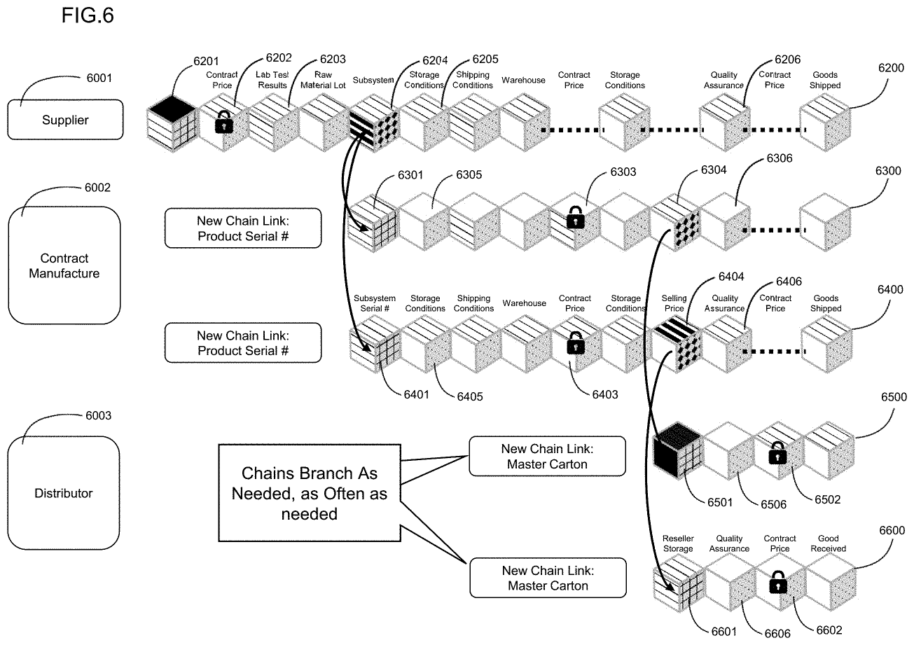

The proposed solution is flexible in data capture technologies (some fully automated), the mixture of which are operationally and environmentally determined based on the unique requirements at each location 6001, 6002, 6003, for capturing unique identification markers representing virtually any element, process, location, configuration, etc. within an operation and links those identification markers together to create a digital representation of all activities and transactions 6200, 6300, 6400, 6500, 6600 involved in the full supply chain life-cycle of any element or service to be grown, harvested, processed, created, synthesized, manipulated, assembled, tracked, sorted, packaged, stored, provided, shipped, received, used/depleted, disposed or repurposed (FIG. 6). Said flexibility in processes and methodologies allows for the use and amalgamation of existing technologies not previously used together, overcomes the limitations of each technology if used individually, and allows for additional algorithms to create and maintain data association, such as machine learning and artificial intelligence systems.

Passing of data occurs on an autonomous communication network (mobile and/or stationary) 300, outside of any existing network or integrated system 601, 602, 603, 604 within an operation.

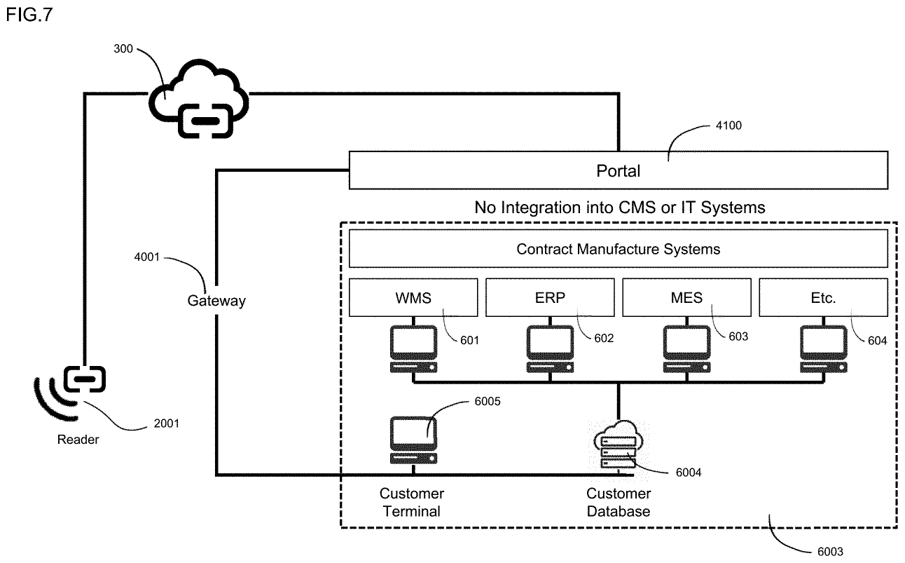

ItemID or TagID data input devices 2000 may reside autonomously on a dedicated network level, and transmit data 300 to the digital data system for algorithmic authentication (FIG. 6). Additionally, if real-time data reads are required within the operation from which the data is captured, the system may allow for a listening port 4100 or similar measure be used to pass direct read data on a local network. For example, a manufacturing 603 or inventory control database system 601. Said readers may transmit data to said local manufacturing or said inventory control database or any other determined data storage location through said listening port, where said data is used in the data structure as required by said local database (FIG. 7).

If required, connectivity of algorithmically authenticated data to a secondary system 6004, 6005, whether operationally integrated or not, is initiated from said digital data system 301, through a secure predetermined gateway 4001. Any data to be passed may only occur once the data has been collected, analyzed, and validated by said authentication algorithms 400 (FIG. 7).

Said data input devices 2001 are often set to read data from a physical storage medium on a known interval basis. While this protocol enables autonomous reads, said interval reads may also produce a large quantity of reads without creating actionable information. Data input devices 2001 may therefore adopt a predetermined reading protocol where reads are locally stored in the onboard memory of said data input device until a predetermined significant change is recorded. A significant change may include, a new TagID 101 is captured by said data input device or a TagID is no longer being captured by the said data input device. This may imply said TagID has been moved into or out of range of said data input device and therefore said TagID position has changed significantly.

Authenticated analyzed data 6204, 6304, 6404 determined to be shared outside of the originating operation may be published on a distributed digital ledger 6000. While transaction data blocks shared on a public distributed digital ledger can be publicly identified for connectivity and traceability between various blocks, data blocks containing sensitive/proprietary transaction data 6202, 6303, 6403, 6502, 6602 can be locked from public access. This method provides linkage traceability between data blocks representing lifecycle events, while protecting sensitive information from being accessed without a privately shared access key (FIG. 6).

Operations requiring data capture in remote locations, data input devices may consist of mobile devices, either using built-in technologies or connected (wired or wireless) external devices, with data being locally processed and stored by the mobile device and transmitted when connectivity is available.

In situations when connectivity is not available the mobile device may process and maintain the data in a local temporary data structure. Upon the next occasion of connectivity, the device may transmit the data to the digital data system. The digital data system may then synchronize the transmitted data to the primary database structure and update the mobile instance.

Making additional data associations between multiple ItemIDs 101 and secondary data may allow for said Algorithm to determine a probabilistic mathematical value 405 of physical authentication and may enable artificial intelligent and/or machine learning algorithms to reduce inefficiencies throughout the lifecycle of the physical goods (FIG. 4). These inefficiencies may include longer than needed transportation routes, identification and traceability, reduction in audits and inspections, and elimination of phantom or excess inventory.

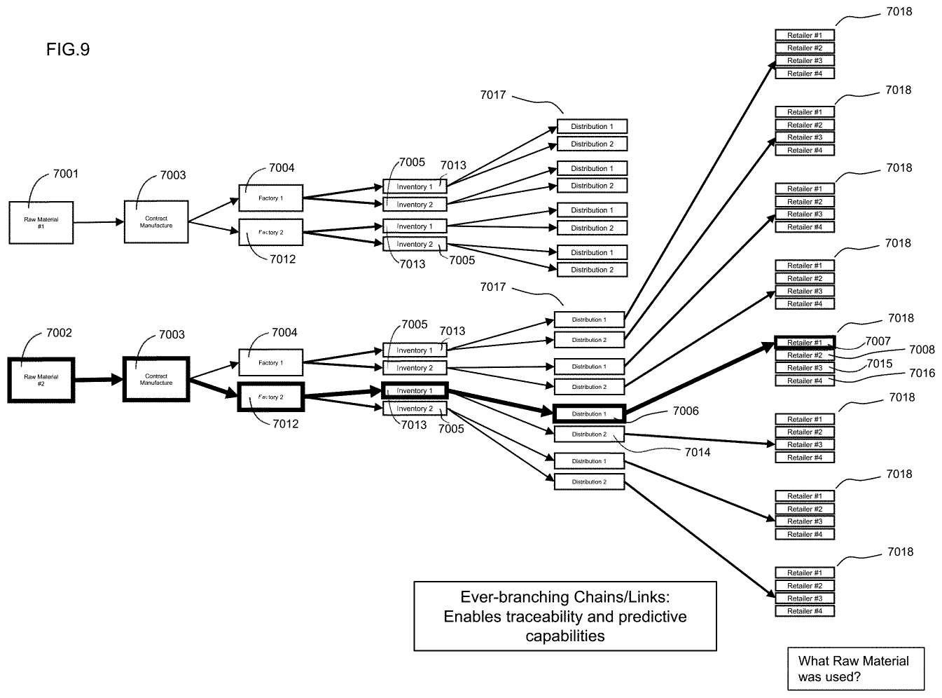

Said algorithm may identify patterns within the data elements to determine linked events and thresholds that result in baseline process expectations (FIG. 9). Once captured 2001, recorded and passed to the data storage system 4001, 4002, 4003, 4004, each recorded event is analyzed both within its own metadata elements, characteristics and parameters, as well as its comparative relation to other event records within the data to determine the mathematical probabilistic physical authentication value 405 (FIG. 2, FIG. 3, FIG. 4). Said baseline understandings, associations, durations and relationships are continually refined as more data elements are introduced over time, validated against existing calculations and given authentication values to characterize the trusted levels of those events/interactions in relation to established expectations. Once validated and authenticated, highly consistent events establish landmark events, against which other data elements are compared, contrasted and validated to calculate their probabilistic authentication value. In one embodiment, ItemID and TagID read data capture events with inherent authentication measures, such as RFID, NFC and other technologies in development are given high authentication probability values.

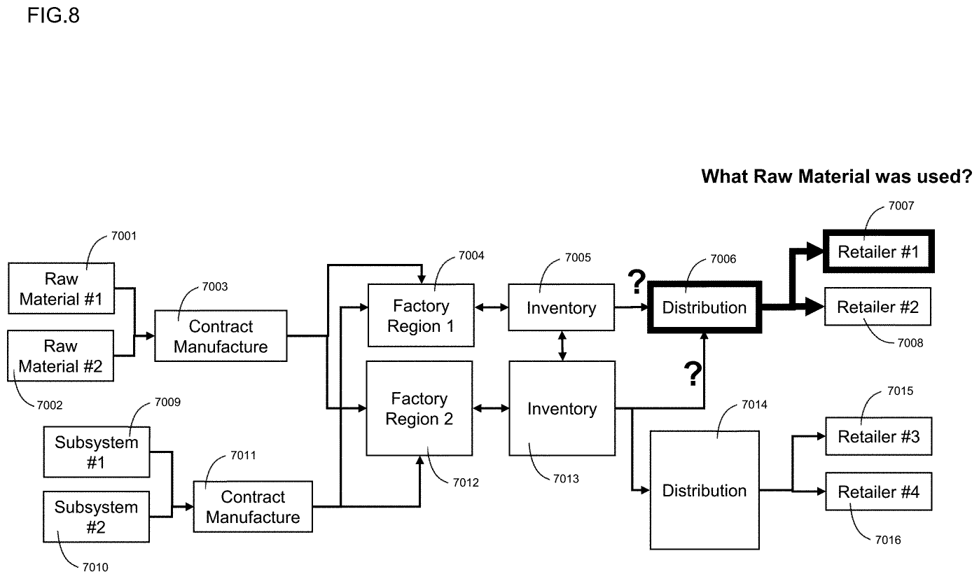

Additionally, technology used to perform physically authenticated tag reads, such as RFID, offer advantages over traditional bar code scans. Tag scans may be recorded without adding workflow steps or processing time as is common with barcode scanning (FIG. 8). TagIDs associated with ItemIDs cannot be duplicated or falsified as with a facsimile of a barcode. If authentication is not required at a specific read point, a barcode tag may be used to represent the ItemID.

Example, if a distribution center records Out-bound products which are not associated with In-bound authenticated products, said algorithm may determine Out-bound products have a high probability of being counterfeit products.

In another example, if the association of a TagID and an ItemID transmitted with secondary data equate with the known association of said TagID and ItemID, then the secondary data may be assumed to have a higher probability of authentication compared to secondary data received without an associated TagID and ItemID.

Utilizing a distributed and shared digital ledger 6000 offers several advantages. A single source of data reduces data conflicts and the need for data reconciliation. A shared data system increases trust between involved parties. Furthermore, a distributed ledger creates data record backups of a single trusted source without created data reconciliation issues. Utilizing a public ledger with lockable blocks 6202, 6303, 6403, 6502, 6602 allows for additional data association (FIG. 6).

Data may also be linked or associated between tags, authenticated reads or non-authenticated reads, as well as associative data between ledger blocks. Associating the data allows for participants to be granted access to valuable data for connectivity and traceability between various organizations and companies, while data blocks containing sensitive/proprietary transaction data can be locked from public access (FIG. 6, FIG. 9). This method provides traceability between data blocks representing lifecycle events, while protecting sensitive information from being accessed without a privately shared access key.

The following is a detailed example of tracing test results for a set of manufactured products created from a batch of raw material. An ItemID is designated as a primary BatchID assigned to the batch of raw material at the start of production. During processing of the raw material into new products, each product is assigned a unique ItemID. For the purpose of this disclosure, the unique ItemID is created using a GS1 standardized and systematically generated Serialized Global Trade Item Number, or SGTIN.

After manufacture of the raw material into products, one individual product may be selected for analysis of composition when analysis results in a destructive test of said product. Said product to be tested may be selected by a system or entity not associated to said manufacture of said product to reduce manipulation of said testing results. Test results of said selected product are associated to said primary BatchID. Therefore, said test results are associated to all SGTINs associated to said BatchID. Additional associations of said test results may be made if said products are further processed into various configurations and incorporated into finished trade products, which are given their own unique identifiers

By utilizing a shared digital ledger, such as Blockchain, to record associations of ItemIDs and test results, said data record access may be enabled at any point required through the remaining life-cycle of the product, including disposal/recycling. Such capability may enable disposal/recycling sites to accurately identify dangerous material components, for example heavy metal substances embedded inside an item, so appropriate disposal considerations may be taken, even if the consumer of the item was unaware of said heavy metals presence. Additionally, records may be made available to enable facilities to accurately identify and validate appropriate disposal/recycling as required by regulatory agencies or for disposal compliance programs and fee collection.

Utilizing a global standard, such as SGTIN's, allow for additional associations to other supply chain established unique identifiers, such as Case and Unitized Load association ID's, Shipping IDs such as Serialized Shipping Container Code (SSCC) and location IDs such as Global Location Numbers (GLN).

The continued supply chain assignments, associations and readings (regardless of validation confidence levels) may also be shared through Blockchain records.

The proposed solution analyzes digital ledger entries, such as Blockchain block assignments, both internally managed and externally published, in order to analyze all data points available for an entire life-cycle analysis service (FIG. 9). This allows for authenticated product analytics, such as verified customer reviews from customers who actually received the product being reviewed. In another example, verified data allows for accurate determination of Country of Origin and/or Chain of Custody for products with complex processing and supply chains. It allows for authenticated track-and-traceability for high-value products and products in which consumer confidence of origin source, process conformance or ingredient scrutiny is critical to the public trust.

What is claimed:

1: Method for providing physical authentication for digitally stored data records comprising; a physical medium having a first unique identifier and a second unique identifier stored within; where said physical medium is in communication with a first distributed ledger having said first unique identifier associated with said second unique identifier stored within; where said distributed ledger is operatively connected with a first comparison algorithm providing the following steps;
Receiving said first unique identifier coupled with said second unique identifier, further associated with at least one first additional data element comprising physical attribute information to be stored,
Comparison to said first unique identifier associated with said second unique identifier stored within said distributed ledger,
Determination that received first unique identifier coupled with said second unique identifier is equal to stored first unique identifier associated with said second unique identifier,
Storage of said first additional data element in association with said first unique identifier coupled with said second unique identifier within said distributed ledger.

2: method of claim 1, further providing authentication to at least a second additional data element comprising physical attribute information to be stored following the steps: Further;
Receiving said first unique identifier associated with at least one second additional data element
Storage of said first unique identifier in association with said second additional data element within said distributed ledger
Further;
Receiving said first unique identifier coupled with second unique identifier, further associated with at least a third additional data element
Comparison to said first unique identifier associated with second unique identifier stored within said distributed ledger,
Determination that received first unique identifier coupled with said second unique identifier is equal to stored first unique identifier associated with said second unique identifier,
Storage of third additional data element in association with said first unique identifier coupled with said second unique identifier within said distributed ledger.
Further;
Comparison of third additional data element with second additional data element
Determination of mathematical association of said second additional data element to said third additional data element.
Storage of said mathematical coupling within said distributed ledger.

3: method of claim 1, where said distributed ledger comprising at least one blockchain of linked records.

4: method of claim 1, where said physical storage medium is a component of an automatic identification and data capture technology; further with cryptographic encoding at time of transmission.

5: method of claim 1, where receiving is performed, at least partially, through inductive coupling with said physical storage medium.

6: method of claim 1, where said first comparison algorithm consisting essentially of functions performed by a consent cloud for blockchains.

7: method of claim 2, where said distributed ledger comprising at least one blockchain of linked records

8: method of claim 2, where said physical storage medium is a component of an automatic identification and data capture technology; further with cryptographic encoding at time of transmission

9: method of claim 2, where receiving is performed, at least partially, through inductive coupling with said physical storage medium;

10: method of claim 2, where said first comparison algorithm consisting essentially of functions performed by a consent cloud for blockchains.

11: A system for providing physical authentication for digitally stored data records comprising a physical storage medium, a first unique identifier and a second unique identifier stored within; further, said physical storage medium in communication with a first distributed ledger, having said first unique identifier associated with said second unique identifier stored within; further, said distributed ledger operatively connected with a first comparison algorithm providing the following steps;
Receiving said first unique identifier coupled with said second unique identifier, further associated with at least one first additional data element comprising physical attribute information to be stored,
Comparison to said first unique identifier associated with said second unique identifier stored within said distributed ledger,
Determination that received first unique identifier coupled with said second unique identifier is equal to stored first unique identifier associated with said second unique identifier,
Storage of said first additional data element in association with said first unique identifier coupled with said first element within said distributed ledger.

12: system of claim 8, further providing physical authentication to at least a second additional data element comprising physical attribute information to be stored following the steps:
Further;
Receiving said first unique identifier associated with at least one second additional data element
Storage of said first unique identifier in association with said second additional data element within said distributed ledger
Further,
Receiving said first unique identifier coupled with second unique identifier, further associated with at least a third additional data element of physical attribute information to be stored,
Comparison to said first unique identifier associated with second unique identifier stored within said distributed ledger,
Determination that received first unique identifier coupled with said second unique identifier is equal to stored first unique identifier associated with said second unique identifier,
Storage of said third additional data element in association with said first unique identifier coupled with said first element within said distributed ledger.
Further;
Comparison of said third additional data element with said second additional data element
Determination of mathematical coupling of said second additional data element to said third additional data element
Storage of said mathematical association within said distributed ledger.

13: system of claim 11, where said distributed ledger comprising at least one blockchain of linked records.

14: system of claim 11, where said physical storage medium is a component of an automatic identification and data capture technology; further with cryptographic encoding at time of transmission.

15: system of claim 11, where receiving is performed, at least partially, through inductive coupling with said physical storage medium.

16: system of claim 11, where said first comparison algorithm consisting essentially of functions performed by a consent cloud for blockchains.

17: system of claim 12, where said distributed ledger comprising at least one blockchain of linked records.

18: system of claim 12, where said physical storage medium is a component of an automatic identification and data capture technology; further with cryptographic encoding at time of transmission.

19: system of claim 12, where receiving is performed, at least partially, through inductive coupling with said physical storage medium.

20: system of claim 12, where said first comparison algorithm consisting essentially of functions performed by a consent cloud for blockchains.
